(19) United States
(12) Patent Application Publication
(10) Pub. No.: US 2016/0152794 A1
(43) Pub. Date: Jun. 2, 2016

(54) ELECTRICALLY INSULATING COMPOSITE MATERIAL, METHOD FOR PRODUCING SUCH A MATERIAL AND USE THEREOF AS EN ELECTRICAL INSULANT

(71) Applicants: UNIVERSITE PAUL SABATIER TOULOUSE III, Toulouse (FR); CENTRE NATIONAL DE LA RECHERCHE SCIENTIFIQUE, Paris (FR)

(72) Inventors: Sombel DIAHAM, VILLENEUVE-LES-BOULOC (FR); Thierry LEBEY, TOULOUSE (FR); Marie-Laure LOCATELLI, ESCALQUENS (FR); Francois SAYSOUK, TOULOUSE (FR)

(21) Appl. No.: 14/903,175

(22) PCT Filed: Jul. 8, 2014
(86) PCT No.: PCT/EP2014/064561

§ 371 Date: Jan. 6, 2016

(30) Foreign Application Priority Data
Jul. 8, 2013 (FR) 1356684

(51) Int. Cl. C08K 3/38; C08J 5/18; H01B 3/30; C08K 3/34; H01B 3/46; C08K 7/18; C08K 3/28

(52) U.S. Cl. CPC C08K 3/38; C08K 7/18; C08J 5/18; C08K 3/28; C08K 3/34; H01B 3/46; H01B 3/306; C08K 2003/385; C08K 2003/282; C08J 2379/08; C08J 2383/04

(57) ABSTRACT

The electrically insulating material, includes a thermostable and electrically insulating polymer matrix wherein electrically insulating inorganic nanoparticles of all sizes smaller than or equal to 200 nm are dispersed. The material is especially applicable as an electrical insulant, especially in the form of a film, in electrical, electronic or electro technical systems wherein it may be subjected to temperatures higher than 200° C. and strong electric fields.

The present invention comes within the field of electrical insulation, in particular of components of electronic, electrical or electrical engineering systems liable to be subjected to high temperatures and to strong electric fields, in particular of electrical energy conversion or storage systems. More particularly, the invention relates to an electrically insulating material based on a polymer matrix and on inorganic nanoparticles, and to a method for the manufacture of such a material. In addition, the invention relates to the use of such a composite material, in particular in the form of a film, as electrical insulator and to an electrical, electronic or electrical engineering system in which this material is employed as electrical insulator.

The components of electrical, electronic or electrical engineering systems are frequently subjected to high temperatures, at which it is desirable for them to be able to operate, and furthermore reliably. This requirement has become increasingly acute as the temperatures to which the components of such systems are subjected become increasingly high. For example, the trend towards the miniaturization of electronic systems having a high heat dissipation and/or on-board electronic systems, in particular in the aeronautical, rail traction and space fields, results in an increase in the power density of their active components. The components of these systems are for this reason subjected to increasingly high operating temperatures, at the same time as to harsher voltage and electric field conditions.

Conventionally, use is made, in order to carry out the intrinsic or extrinsic insulation of the components of electronic systems, for example the surface insulation of semiconductors or intercomponent insulation in the field of microelectronics and in particular of power microelectronics, of coatings of electrical insulating polymer materials, such as polyimides, chosen for their high thermal stability and their mechanical properties compatible with an application, in the thin layer form, as electrical insulators within such systems.

However, it has been observed by the present inventors that the electrical insulation properties of such polymers deteriorate under the effect of an increase in temperature, in particular for temperatures of greater than 200° C.

More particularly, the electrical insulating heat-stable polymer materials conventionally used in electrical/electronic/electrical engineering systems, such as polyimides, exhibit a strong deterioration in their electrical insulation and dielectric properties in the temperature range above 200° C., which is reflected in particular by an increase in the direct current resistivity and dielectric losses and by a fall in the dielectric breakdown field. These materials thus become semi-insulating. By way of example, as regards polyimides, it is observed that the DC volume resistivity (ρ) becomes less than 10¹² Ω·cm and the dielectric loss factor (tan δ) becomes greater than 10%, above 200° C. Furthermore, the breakdown field collapses with the increase in the temperature, with decreases which can range up to more than 50% with respect to its value at 25° C. These materials thus become technically not very effective, indeed even failing, above 200° C.

It thus proves to be desirable to have available an electrical insulating material which exhibits the advantageous properties of the polymer materials provided by the prior art for the electrical insulation of components of electronic systems, in terms of thermal stability and of mechanical properties, while exhibiting an electrical insulating performance at high temperatures, typically above 200° C., including under a strong electric field, so as to ensure the reliability of operation of the systems within which it is employed as electrical insulator. The present invention aims at providing a material exhibiting such properties.

With an objective entirely different from that of the present invention, the proposal has been made, in the prior art, to modify the electrically insulating polymer materials, more particularly based on polyimide, by incorporating a mineral filler therein, more specifically boron nitride particles, this being done in order to improve the thermal properties thereof.

Mention may be made, by way of example of such a prior art, of the publication by Sato et al. (2010), which describes a composite material based on a polyimide matrix in which boron nitride particles are dispersed, the size of these particles being less than 0.7 μm and a specific surface of these particles being 13 m²·g⁻¹, or also the publication by Li et al. (2011), which also describes a material based on a matrix of a polyimide in which boron nitride particles are dispersed. The mean size of these particles is described as equal to 70 nm. It appears, from the figures of this document, in particular from FIG. 3, that a not insignificant amount of these particles exhibit dimensions of the order of several hundred nanometers. As set out above, the object of these prior studies was to improve the thermal conduction properties of polyimide-based materials. None of these documents is concerned with the electrical insulation properties of the materials proposed.

It has now been discovered by the present inventors that, entirely surprisingly and remarkably, the electrical insulation properties of electrically insulating heat-stable polymer materials, in particular polyimides, are greatly improved at temperatures of greater than 200° C., including under strong electric field conditions, when electrically insulating inorganic nanoparticles, corresponding to very precise size characteristics, are incorporated in a matrix of such polymers.

Thus, an electrically insulating material, comprising a matrix of a heat-stable and electrically insulating polymer, in which electrically insulating inorganic nanoparticles are dispersed, is provided according to the present invention. These electrically insulating inorganic nanoparticles are chosen from electrically insulating metal nitrides, diamond, electrically insulating oxides of at least one metal from Groups 1 to 11 of the Periodic Table of the Elements, and their mixtures, and all of these electrically insulating inorganic nanoparticles exhibit dimensions of less than or equal to 200 nm. This is understood to mean that each of the nanoparticles is such that none of its spatial dimensions is greater than 200 nm. The material according to the invention differs in this from the materials provided by the prior art, in particular by the publication by Li et al. (2011), in which a non-insignificant amount of the particles exhibit at least one dimension greater than 200 nm.

The term “electrically insulating polymer” is understood to mean, in the present description, a polymer exhibiting electrical insulation properties at ambient temperature, that is to say at approximately 25° C.

The term “heat-stable polymer” is understood to mean, within the meaning of the present invention, a polymer with a weight which is substantially retained when it is subjected to a rise in temperature, at least up to a temperature of 350° C., that is to say that the weight loss is less than 10% in thermogravimetric analysis, measured at 10° C./min. Depending on the applications for which the material is intended, in particular for high-temperature applications, for example above 250° C., the choice is advantageously made according to the invention, for the composition of the material, of a polymer for which, at least up to a temperature of 400° C., the loss in weight is less than 5% in thermogravimetric analysis, measured at 10° C./min.

In addition, the electrically insulating nanoparticles are herein defined in a way conventional in itself as nanoparticles with an electrical conductivity of less than or equal to 10⁻¹¹ Ω⁻¹·cm⁻¹. Such a definition excludes in particular titanium oxide (TiO₂) nanoparticles, which are semi-insulating and exhibit an electrical conductivity greater than this value, as described in the publication by Feng et al. (2013).

The material according to the present invention advantageously retains electrical insulation properties at high temperatures, including greater than 200° C., both in direct current (DC) and in alternating current (AC), and under strong electric field. In the range of temperatures from 200 to 400° C., it thus exhibits electrical and dielectric properties which are very greatly improved with respect to the materials provided by the prior art.

In particular, for the material in accordance with the invention, the direct current dielectric breakdown field does not deteriorate above 200° C., in contrast to the materials of similar composition but in which a portion at least of the particles exhibit at least one dimension greater than 200 nm, as are provided by the prior art. In comparison with such materials and with the materials composed of the filler-free polymer, the values of the breakdown field are very significantly increased.

In addition, all of the other dielectric properties of the material according to the invention are also improved, with respect to the materials of the prior art. At high temperatures, of greater than 200° C., the material according to the invention in particular exhibits, in comparison with the filler-free polymers: values of the dielectric loss factor at a frequency of 1 kHz which are reduced by a factor of 5 to 1000; values of the DC volume resistivity which are greatly increased by a factor of 1000 to 100 000; and leakage current densities which are decreased, including under strong electric fields, more particularly decreased by a factor of 10 to 100 000 under electric fields of greater than 10 kV/mm.

The material according to the invention, retaining its electrical insulating properties in a range of temperatures and of electric fields in which homogeneous polymers not comprising nanoparticles as fillers or polymers comprising nanoparticles of greater size as fillers lose the same properties and become semi-insulating, thus makes it possible to overcome the disadvantages of the materials of the prior art in terms of high-temperature electrical insulation. It thus advantageously meets the strict requirements of the fields of the conversion and of the storage of electrical energy in the range of temperatures from 200 to 400° C., in particular under a strong electric field.

This material has applications in particular, but not limitingly, as electrical insulator in electrical, electronic and electrical engineering systems, such as: capacitors for high-temperature and high-voltage energy storage having low dielectric losses; high-temperature, high-voltage and strong-electric-field electronic power systems; systems of the electrical engineering field, such as motors, electric machines, operating under severe constraints of temperature, voltage, pressure, and the like, including for the insulation of transformers, cables, and the like; systems having a high power density, such as integrated, optical, optoelectronic, photovoltaic conversion and microwave systems, and the like; and more generally any system requiring electrical insulation solutions under high temperature and strong electric field, in particular in the fields of transportation, industry, oil production, geothermal research, space, and the like. It can also be employed for the insulation by passivation or encapsulation of metalized substrates, for example chips made of silicon carbide, of diamond or of gallium nitride, and intermetallic insulation layers, and the like.

The use of the material according to the invention in such systems advantageously makes it possible in particular:
to increase the lifetime of the conversion systems by the improvement of the reliability of the insulation systems which are employed therein, and also to decrease the costs related to maintenance;
to decrease the weight and the volume of electrical energy conversion systems, thus making it possible to incorporate them and/or to increase their ability to operate at higher temperature. This is reflected in particular by a decrease in the consumption of fossil energy, an increase in the number of passengers taken on board vehicles, such as aircraft or trains, and so on.

According to particular embodiments, the material according to the invention corresponds in addition to the following characteristics, implemented separately or in each of their technically effective combinations.

In particularly advantageous embodiments of the invention, all of the electrically insulating inorganic nanoparticles dispersed in the matrix exhibit dimensions of less than or equal to 100 nm, that is to say that none of their spatial dimensions is greater than 100 nm.

In specific embodiments of the invention, the electrically insulating inorganic nanoparticles which are present as a dispersion in the polymer matrix exhibit an overall spherical shape. In addition, these nanoparticles can exhibit any crystallographic form, in particular cubic or hexagonal.

According to an advantageous characteristic of the invention, in terms of efficiency of the electrical insulation at high temperature and under a strong electric field, the electrically insulating inorganic nanoparticles exhibit a monomodal size distribution.

In addition, their density is preferably less than 2 g/cm³. Such a characteristic advantageously facilitates their dispersion in the polymer matrix and also the use of the material according to the invention, in particular for high contents of loading by volume of the polymer matrix with nanoparticles.

In particular embodiments of the invention, the electrically insulating inorganic nanoparticles are present in the polymer matrix in a ratio by volume of 0.1 to 95%, in particular of 1 to 95%, preferably of 20 to 60%, more preferably of 20 to 50% and preferentially of 35 to 45%.

For some types of particles, a rate of loading by volume of between 35 and 45% proves to be particularly advantageous from the viewpoint of the dielectric breakdown field, which exhibits the highest values for this range of concentration by volume, while ensuring great ease of handling of the material.

Otherwise, the ratio by volume of electrically insulating inorganic nanoparticles in the polymer matrix can be between 0.1 and 45%.

According to a particularly advantageous characteristic of the invention, the electrically insulating inorganic nanoparticles are dispersed in the polymer matrix so as not to form any agglomerate having a size of greater than or equal to 2 μm, preferably of greater than or equal to 1 μm.

The heat-stable and electrically insulating polymer participating in the composition of the matrix of the material according to the invention can be chosen from any polymer, including copolymer, corresponding to such characteristics. It can equally well be a polymer of the thermosetting type as a polymer of the elastomer type.

When the polymer is of the thermosetting type, it preferably exhibits a glass transition temperature of greater than or equal to 200° C., in particular of greater than or equal to 250° C., depending on the application targeted for the material and the temperatures to which it is likely to be subjected.

The heat-stable and electrically insulating polymer according to the invention can in particular consist of a silicone material, for example in the form of gel, of elastomer or of polydimethylsiloxane (PDMS).

Otherwise, the polymer can consist of a polymer of epoxy type, of cyanate ester type, or of any other heat-stable and electrically insulating polymer, in particular of polymers the precursors of which can be dissolved in a solvent. Mention may be made, as examples of such polymers, of polymers of the following types: polyimide (PI), polyamideimide (PAI), polyetherimide (PEI), polyetheretherketone (PEEK), benzocyclobutene (BCB), polyethersulfone (PES), polyaryletherketone (PAEK), polyimide-siloxane, polyisoindoloquinazolinedione, polyphenylquinoxaline, polyquinixalone, polyquinoline, polyquinoxaline, polybenzimidazole (FBI), polybenzoxazole (PBO), poly(arylene ether), polysilane, poly(perfluorocyclobutane) and their derivatives.

In specific embodiments of the invention, the electrically insulating heat-stable polymer is a polyimide, for example of biphenyltetracarboxylic acid dianhydride (BPDA)/p-phenylenediamine (PDA) type.

In specific embodiments of the material according to the invention, the electrically insulating inorganic nanoparticles comprise metal nitride nanoparticles or consist of metal nitride nanoparticles.

The electrically insulating inorganic nanoparticles are, for example, chosen from aluminum nitride (AlN), boron nitride (BN) or silicon nitride (Si₃N₄) nanoparticles or their mixtures. They comprise in particular boron nitride nanoparticles. They are, for example, constituted solely of boron nitride nanoparticles.

The electrically insulating inorganic nanoparticles can be or can comprise diamond (C) nanoparticles.

In addition, they can be or can comprise nanoparticles of oxide of a metal of Groups 1 to 11 of the Periodic Table of the Elements, for example of a metal of Group 1, of a metal of Group 2, such as magnesium, beryllium, strontium or calcium, of a metal of Group 3, of a metal of Group 4, such as zirconium or hafnium, of a metal of Group 5, of a metal of Group 6, of a metal of Group 7, of a metal of Group 8, of a metal of Group 9, of a metal of Group 10 or of a metal of Group 11 of the Periodic Table of the Elements, such as copper.

The electrically insulating inorganic nanoparticles are, for example, chosen from zirconium oxide (ZrO₂) nanoparticles, magnesium oxide (MgO) nanoparticles, copper oxide nanoparticles, beryllium oxide nanoparticles, strontium and titanium oxide nanoparticles, and the like, or their mixtures. Such metal oxides can, if appropriate, comprise one or more additional metals belonging or not belonging to Groups 1 to 11 of the Periodic Table of the Elements.

The material according to the invention can be provided in different forms, depending on the application targeted. It can in particular be presented in the form of granules, to be shaped according to the desired configuration.

In specific embodiments of the invention, the material is shaped in the form of a film. This film preferably exhibits a thickness of between 100 nm and 1 cm, preferably between 100 nm and 1 mm, preferentially of between 1 and 100 μm and more preferably of between 1 and 10 μm.

Otherwise, the material according to the invention can be shaped with a greater thickness, in particular for the encapsulation of electrical and/or electronic components.

According to another aspect, the present invention relates to a method for the manufacture of a material according to the invention having one or more of the above characteristics. This method comprises successive steps of:
dispersing electrically insulating inorganic nanoparticles, all exhibiting dimensions of less than or equal to 200 nm, in a liquid composition comprising one or more precursor(s) of a heat-stable and electrically insulating polymer, if appropriate in solution in a solvent, in particular when the precursor(s) do not exist in the liquid form,
shaping the dispersion thus obtained, in particular by deposition in the form of a film,
and heating under conditions capable of bringing about the crosslinking of the polymer and the removal of the solvent.

If appropriate, the electrically insulating inorganic nanoparticles can be predispersed in a solvent, prior to the mixing thereof with the precursor(s) of the heat-stable and electrically insulating polymer.

In particular embodiments of the invention, the electrically insulating inorganic nanoparticles are introduced into the liquid composition in an amount such that the final rate of loading by volume of the matrix with nanoparticles is between 0.1 and 95%, in particular between 1 and 95%, preferably from 20 to 60%, more preferably from 20 to 50% and preferentially between 35 and 45%.

Prior to their introduction into the liquid composition, the nanoparticles may have been subjected to any appropriate preliminary treatment, for example a surface pretreatment aiming at facilitating their dispersion in the liquid composition. In the specific case in which the material comprises boron nitride nanoparticles, it is in particular entirely advantageous for these nanoparticles to have been subjected to a preliminary drying step, in particular by heat treatment, because of their intrinsic hygroscopic nature.

In specific embodiments of the invention, the step of dispersing the nanoparticles in the liquid composition comprises the mechanical mixing of the nanoparticles in this liquid composition and then the sonification of the mixture thus obtained, so as to provide, by a cavitation phenomenon which takes place under the action of the ultrasound, the breaking of the agglomerates of nanoparticles and thus a good dispersion of the latter in the composition.

According to a particularly advantageous characteristic of the invention, the step of dispersing the nanoparticles in the liquid composition can be followed by a step of removing the agglomerates having a size of greater than or equal to 2 μm, preferably of greater than or equal to 1 μm. This step of removal of the agglomerates of micrometric size is preferably carried out by separation by settling using centrifuging. It is within the competence of a person skilled in the art to determine the centrifuging operating conditions, in particular with regard to speed and duration, so as to carry out the removal of the agglomerates of micrometric size. The supernatant, comprising the “nanometric” phase, devoid of agglomerates of micrometric size, is then used for the subsequent shaping step.

This shaping is in particular carried out by deposition of the dispersion obtained in the form of a film, especially with a thickness of between 100 nm and 1 cm, preferably between 100 nm and 1 mm, preferentially between 1 and 100 μm and more preferably between 1 and 10 μm.

Another aspect of the invention is an electrically insulating film formed based on a material according to the invention. This film might be obtained by a method as described above. It preferably exhibits a thickness of between 100 nm and 1 cm, preferably between 100 nm and 1 mm, preferably between 1 and 100 μm and preferentially between 1 and 10 μm.

According to another aspect, the present invention relates to the use of a material in accordance with the invention, having one or more of the above characteristics, as electrical insulator, in particular in an electrical, electronic or electrical engineering system, for example in a system for the conversion or the storage of electrical energy.

This use can in particular be carried out at a temperature of greater than 200° C., the material according to the invention exhibiting electrical and dielectric properties which are entirely advantageous at such high temperatures. In addition, it can be carried out under harsh electrical conditions, in particular under a strong electric field, for example of at least 10 kV/mm.

The material according to the invention can in particular be applied on a support to be electrically insulated, in the form of a film with a thickness of between 100 nm and 1 cm, preferably between 100 nm and 1 mm, preferably between 1 and 100 μm and preferentially between 1 and 10 μm.

The present invention also relates to an electrical, electronic or electrical engineering system which comprises, as electrical insulator of at least one of its components, whether an active component or a passive component, a film of a material according to the invention having one or more of the above characteristics. Such a system can in particular consist of a system for the conversion or the storage of electrical energy, such as a capacitor, a power module, and the like, liable to have to operate in a high-temperature environment and under a strong electric field, a semiconductor system, an integrated system, and the like. Examples of such systems have been listed in detail above, as well as the advantages of the use of the material according to the invention as electrical insulator within such systems.

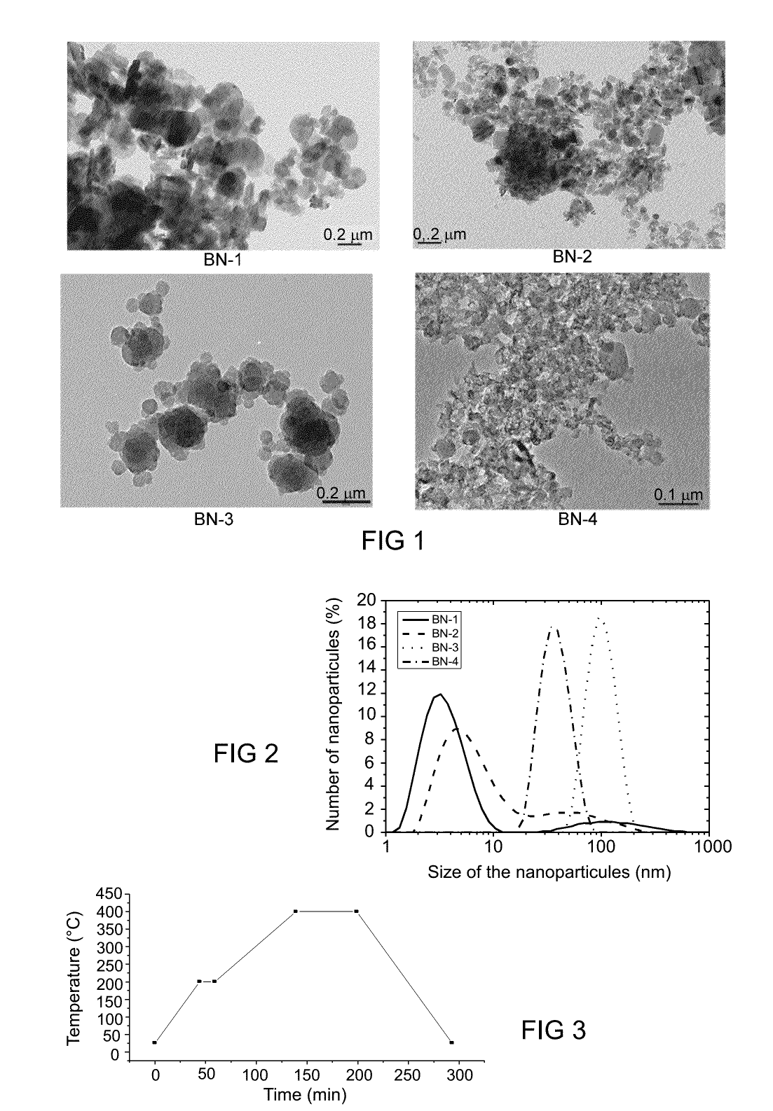

The characteristics and advantages of the invention will become more clearly apparent in the light of the examples below, provided simply by way of illustration of and without any limitation on the invention, with the support of FIGS. 1 to 21, in which:

FIG. 1 represents transmission electron microscopy images obtained for two batches of boron nitride nanoparticles not in accordance with the invention (BN-1) and (BN-2) and for two batches of boron nitride nanoparticles in accordance with the invention (BN-3) and (BN-4);

FIG. 2 shows a graph representing the size distribution of the nanoparticles, measured by laser particle size analysis at a wavelength of 633 nm, on a dispersion of 0.1 g of particles in 10 ml of ethanol, for two batches of boron nitride nanoparticles not in accordance with the invention (BN-1) and (BN-2) and for two batches of boron nitride nanoparticles in accordance with the invention (BN-3) and (BN-4);

FIG. 3 is a graph showing the temperature cycle of the final step of manufacture of materials based on boron nitride nanoparticles dispersed in a polyimide matrix;

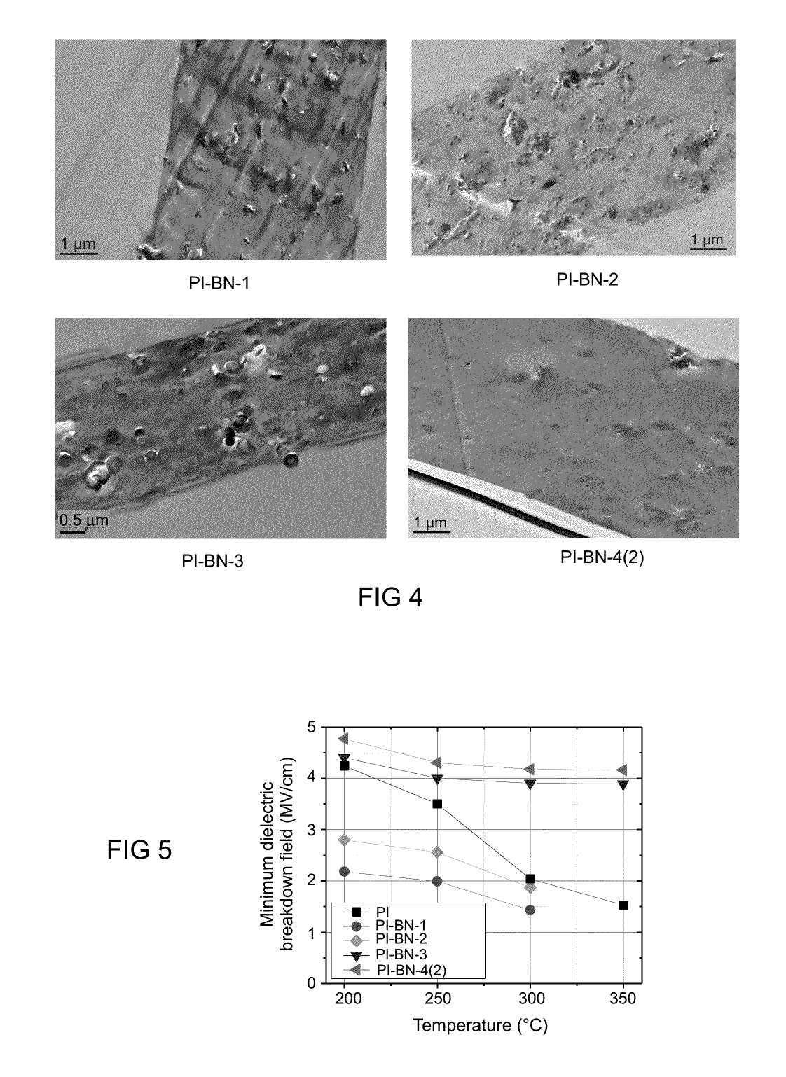

FIG. 4 represents transmission electron microscopy images obtained for films of materials based on polyimide and on boron nitride particles not in accordance with the invention (PI-BN-1 and PI-BN-2) and for films of materials based on polyimide and on boron nitride particles in accordance with the invention (PI-BN-3 and PI-BN-4(2));

FIG. 5 is a graph representing the minimum dielectric breakdown field, obtained from 20 samples, as a function of the temperature, for films of materials based on polyimide and on boron nitride particles in accordance with the invention (PI-BN-3 and PI-BN-4(2)), for films of materials based on polyimide and on boron nitride particles not in accordance with the invention (PI-BN-1 and PI-BN-2) and for a film of the same polyimide not comprising nanoparticles as filler (PI);

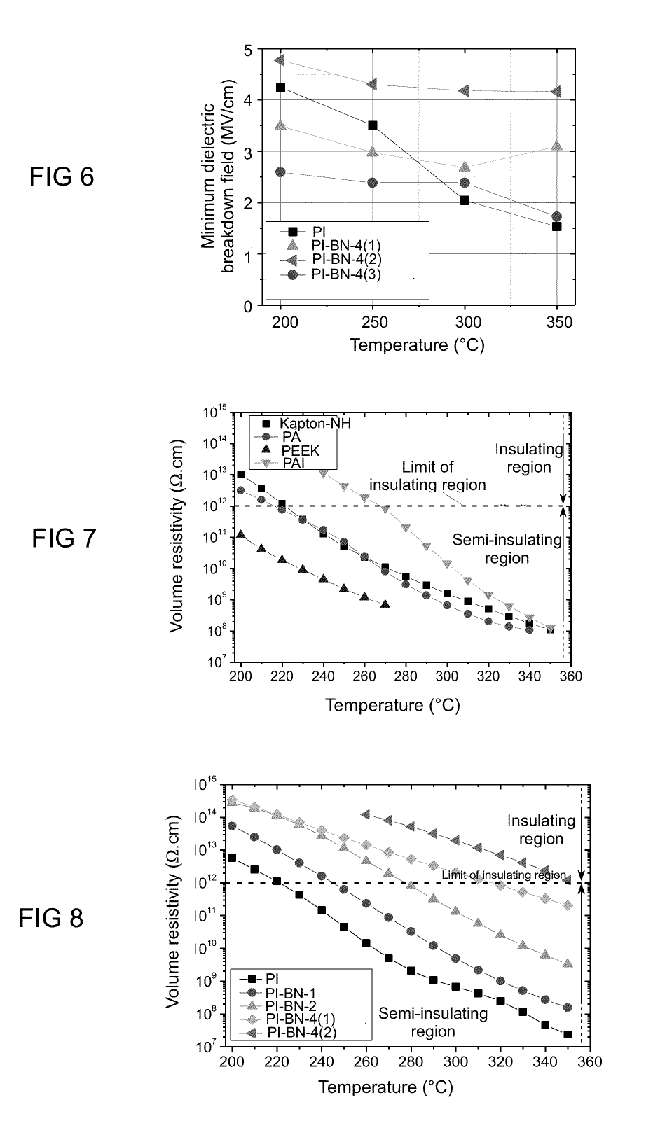

FIG. 6 shows a graph representing the minimum dielectric breakdown field, obtained from 20 samples, as a function of the temperature, for films of materials based on polyimide and on boron nitride particles in accordance with the invention (PI-BN-4(1), PI-BN-4(2), PI-BN-4(3)), of similar constitution but exhibiting different rates of loading with nanoparticles;

FIG. 7 shows a graph representing the volume resistivity as a function of the temperature for films of different conventional electrically insulating polymers;

FIG. 8 shows a graph representing the volume resistivity as a function of the temperature for films of materials based on polyimide and on boron nitride particles in accordance with the invention (PI-BN-4(1) and PI-BN-4(2)), for films of materials based on polyimide and on boron nitride particles not in accordance with the invention (PI-BN-1 and PI-BN-2) and for a film of the same polyimide not comprising nanoparticles as filler (PI),

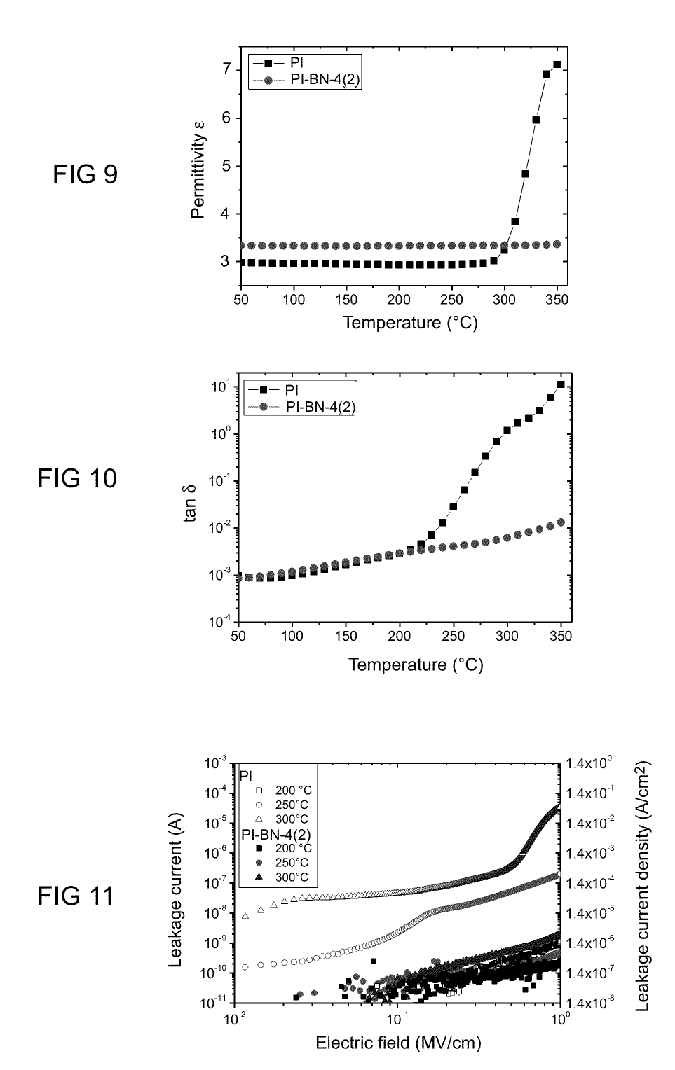

FIG. 9 shows a graph representing the change in the permittivity (c) at 1 kHz, as a function of the temperature, for a material in accordance with the invention (PI-BN-4(2)) and for the comparative material formed by the same polymer (PI) not comprising nanoparticles as filler;

FIG. 10 shows a graph representing the change in the dielectric loss factor (tan δ) at 1 kHz, as a function of the temperature, for a material in accordance with the invention (PI-BN-4(2)) and for the comparative material formed by the same polymer (PI) not comprising nanoparticles as filler;

FIG. 11 shows a graph representing the change in the leakage currents, as a function of the electric field, for three different temperatures (200° C., 250° C. and 300° C.), for a material in accordance with the invention PI-BN-4(2) and for the comparative material formed by the same polymer (PI) not comprising nanoparticles as filler;

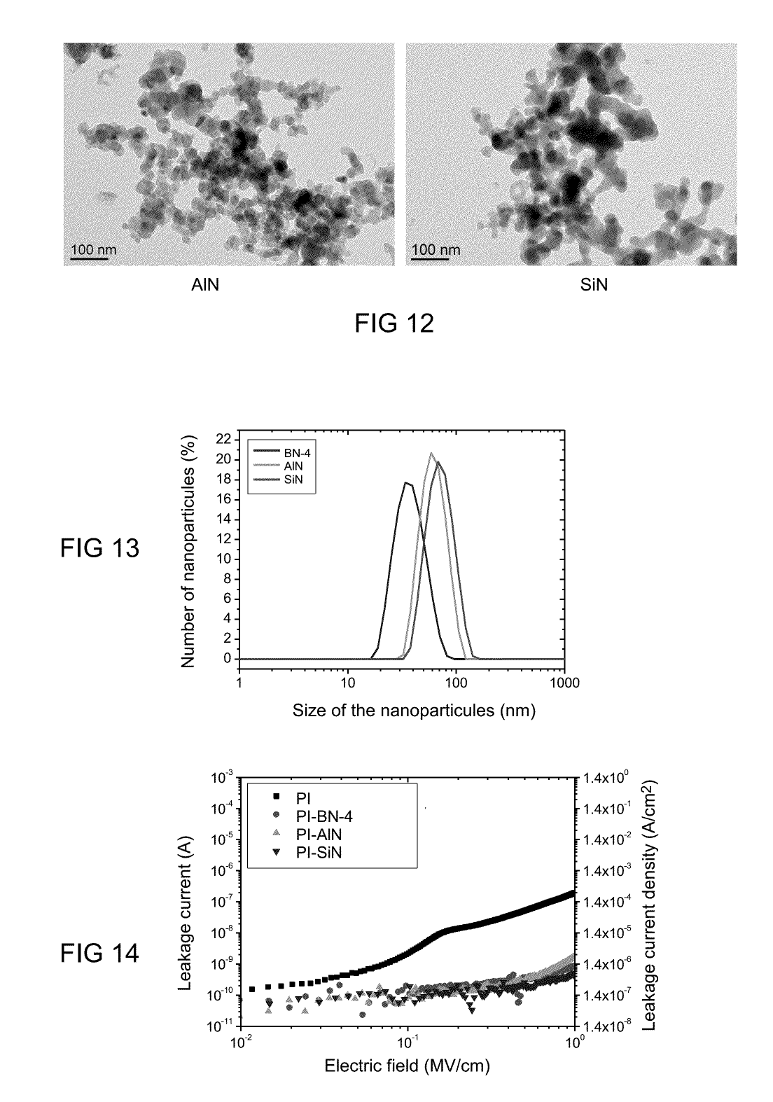

FIG. 12 represents transmission electron microscopy images obtained for aluminum nitride (AlN) nanoparticles and for silicon nitride (SiN) nanoparticles in accordance with the invention;

FIG. 13 shows a graph representing the size distribution of the nanoparticles, measured by laser particle size analysis at a wavelength of 633 nm, on a dispersion of 0.1 g of particles in 10 ml of ethanol, for aluminum nitride (AlN) particles and for silicon nitride (SiN) nanoparticles in accordance with the invention, and also for a batch of boron nitride nanoparticles in accordance with the invention (BN-4);

FIG. 14 shows a graph representing the change in the leakage currents, as a function of the electric field, at the temperature of 250° C., for materials in accordance with the invention PI-BN-4, PI-AlN and PI-SiN and for the comparative material formed by the same polymer (PI) not comprising nanoparticles as filler;

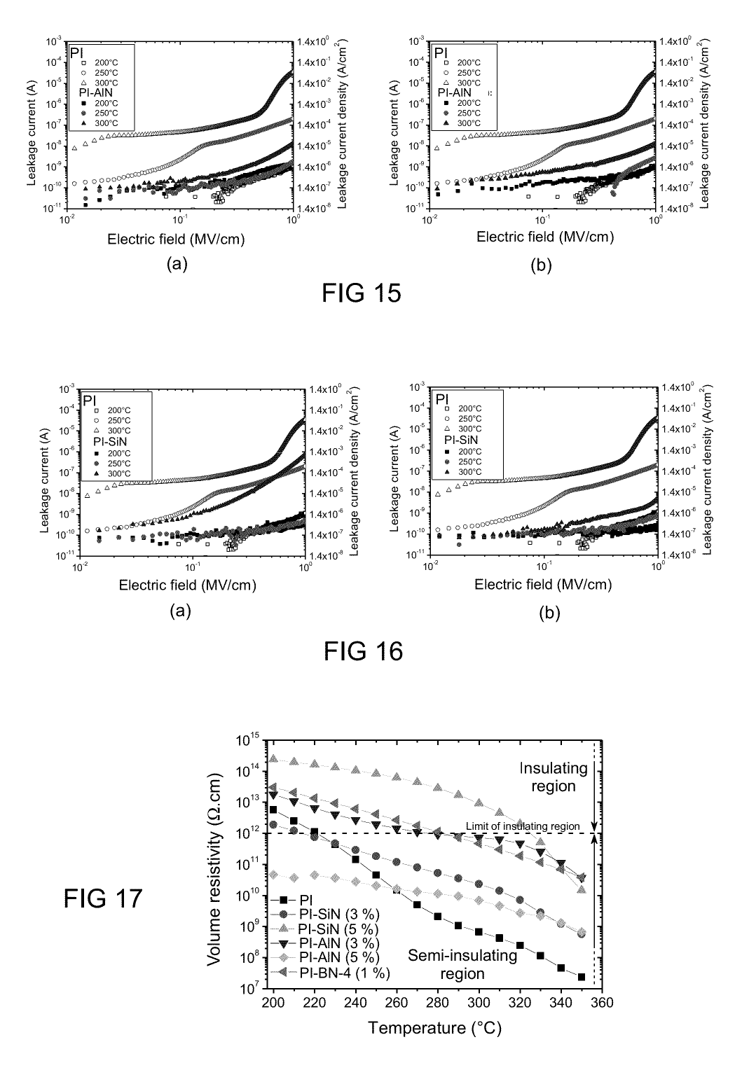

FIG. 15 shows graphs representing the change in the leakage currents, as a function of the electric field, for three different temperatures (200° C., 250° C. and 300° C.), for the comparative material formed by the same polymer (PI) not comprising nanoparticles as filler and for a material in accordance with the invention PI-AlN, at rates of loading by weight with nanoparticles of (a) 3% and (b) 5% respectively;

FIG. 16 shows graphs representing the change in the leakage currents, as a function of the electric field, for three different temperatures (200° C., 250° C. and 300° C.), for the comparative material formed by the same polymer (PI) not comprising nanoparticles as filler and for a material in accordance with the invention PI-SiN, at rates of loading by weight with nanoparticles of (a) 3% and (b) 5% respectively;

FIG. 17 shows a graph representing the volume resistivity, as a function of the temperature, for films of materials based on polyimide and on particles in accordance with the invention PI-BN-4, PI-AlN and PI-SiN, at rates of loading by weight with nanoparticles of 1%, 3% or 5%, and for a film of the same polyimide not comprising nanoparticles as filler (PI);

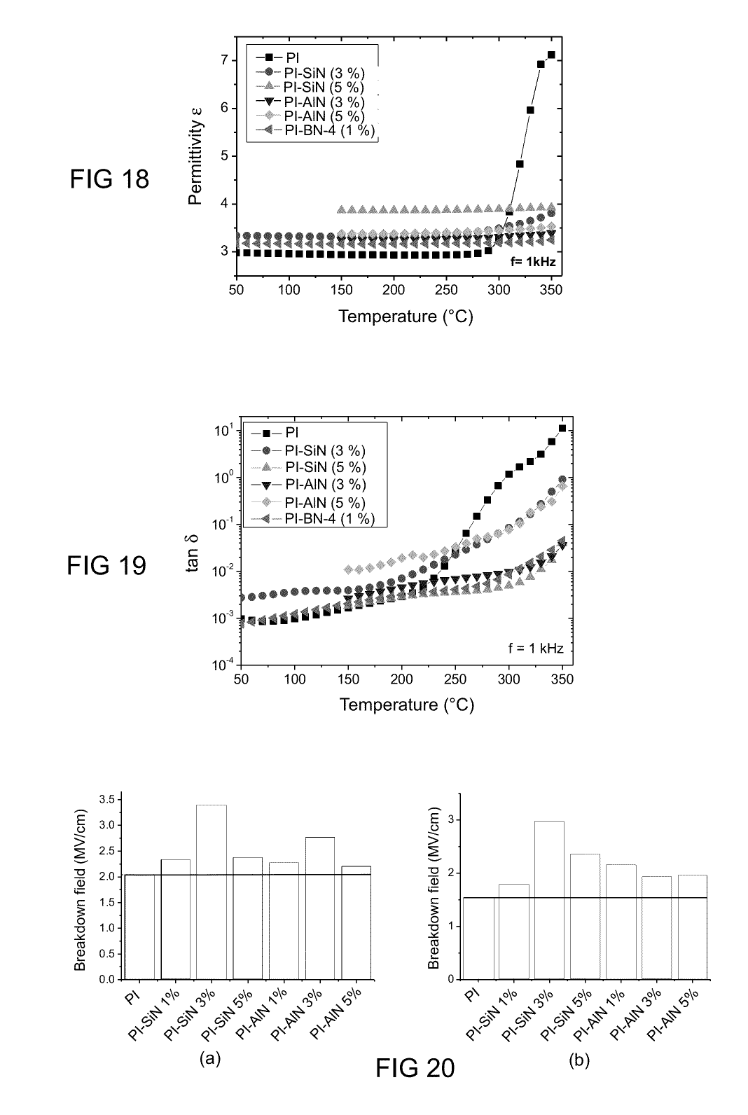

FIG. 18 shows a graph representing the change in the permittivity (c) at 1 kHz, as a function of the temperature, for materials in accordance with the invention PI-BN-4, PI-AlN and PI-SiN, at rates of loading by weight with nanoparticles of 1%, 3% or 5%, and for the comparative material formed by the same polymer (PI) not comprising nanoparticles as filler;

FIG. 19 shows a graph representing the change in the dielectric loss factor (tan δ) at 1 kHz, as a function of the temperature, for materials in accordance with the invention PI-BN-4, PI-AlN and PI-SiN, at rates of loading by weight with nanoparticles of 1%, 3% or 5%, and for the comparative material formed by the same polymer (PI) not comprising nanoparticles as filler;

FIG. 20 is a graph representing the minimum dielectric breakdown field, at the respective temperatures of (a) 300° C. and (b) 350° C., for films of materials based on polyimide and on nitride particles in accordance with the invention PI-AlN and PI-SiN, at rates of loading by weight with nanoparticles of 1%, 3% or 5%, and for a film of the same polyimide not comprising nanoparticles as filler (PI);

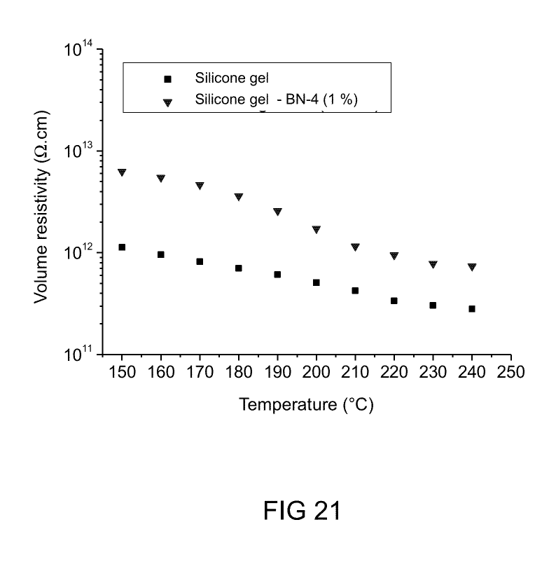

and FIG. 21 shows a graph representing the volume resistivity, as a function of the temperature, for a film of material based on silicone gel and on boron nitride particles in accordance with the invention, at a rate of loading by weight of nanoparticles of 1%, and for a film of the same silicone gel not comprising nanoparticles as filler.

### EXPERIMENT A

### Composite Materials: Polyimide Matrix—Boron Nitride Nanoparticles

### Example 1

### Preparation of Materials in the Film Form

Polymer Matrix

The polymer matrix used in this example is a polyimide of biphenyltetracarboxylic acid dianhydride (BPDA)/p-phenylenediamine (PDA) type, of general formula:

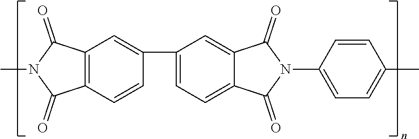

Initially, the two precursor monomers of this polyimide are found in liquid form, dissolved in the polar solvent N-methylpyrrolidone (NMP). This precursor solution is commonly referred to as polyamic acid (PAA), of general formula:

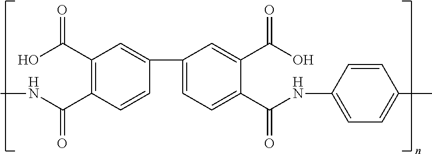

This PAA solution is obtained by the two-stage method of synthesis described in particular in the publication by Sroog (1991), by dissolution of the precursor monomers (in a 1:1 ratio, representing 13.5% by weight) in NMP (86.5% by weight). The viscosity of the PAA solution used is 110-135 poises at 25° C. and its density is 1.082 g/cm³.

The stage of conversion of the PAA into the polyimide (PI) is carried out by a stage of annealing at high temperature, bringing about an imidization reaction of the PAA.

Inorganic Nanoparticles

Different batches of boron nitride (BN) nanoparticles, the characteristics of which are shown in table 1 below, are used to form several materials.

The batches of nanoparticles denoted BN-1 and BN-2 constitute comparative examples and do not correspond to the definition of the present invention.

The batches of nanoparticles denoted BN-3 and BN-4 are in accordance with the present invention.

In addition to the characteristics communicated by the suppliers, the true size characteristics of the nanoparticles of each batch have been established from observations by transmission electron microscopy (TEM), on the one hand, and by laser particle size analysis, on the other hand.

The TEM images were obtained by means of a Jeol JEM1400 transmission microscope, with a voltage of 120 kV. An example of an image obtained for each batch BN-1, BN-2, BN-3 and BN-4 is shown in FIG. 1. It is observed therein that the nanoparticles of batches BN-3 and BN-4 in accordance with the invention all exhibit dimensions of less than 200 nm. Batches BN-1 and BN-2 all comprise nanoparticles exhibiting at least one dimension greater than 200 nm.

The measurement by laser particle size analysis, carried out in a way conventional in itself, consists in determining the distribution in sizes of particles by a technique of diffraction of light resulting from a laser (He—Ne), after suspending the particles by sonification in a liquid solvent. 0.1 g of each of the different batches of nanoparticles was introduced into 10 ml of ethanol and dispersed for 10 min in an ultrasonic bath at a power of 750 W. The measurement device used is a Zetasizer NanoZS90 laser particle sizer. The wavelength of the laser used is 633 nm. The device detects the particles between 0.3 nm and 5 μm, with an uncertainty of +/−2%.

The result obtained for each of the batches, in terms of size distribution of the nanoparticles, is shown in FIG. 2. It is clearly observed therein that batches BN-1 and BN-2 comprise particles of a dimension of greater than 200 nm and a bimodal size distribution, in contrast to batches BN-3 and BN-4, which exhibit a single distribution, with all of the particles having dimensions of less than 200 nm.

The minimum, maximum and mean particle diameters, for each batch and each distribution, are also extracted from these measurements.

The characteristics of the different batches are summarized in table 1 below.

TABLE 1
characteristics of boron nitride particles employed

| Batch | BN-1 | BN-2 | BN-3 | BN-4 |
|---|---|---|---|---|
| Density (g/cm³)* | 2.30 | 2.35 | 1.95 | 1.95 |
| Shape of the | polyhedral | polyhedral | pseudo- | pseudo- |
| nanoparticles | | | spherical | spherical |
| Type of distribution | bimodal | bimodal | monomodal | monomodal |
| of the sizes* | | | | |
| Mean diameter | 3*/120* | 5*/60* | 95* | <40* |
| (nm)* | 70^{#}/80^{#} | NA | 90^{#} | <40^{#} |
| Minimum diameter | <2 | 2 | 55 | 15 |
| (nm)* | | | | |
| Maximum diameter | 420 | 230 | 200 | 90 |
| (nm)* | | | | |
| Specific surface | NA | >80 | 35 | >80 |
| (m²/g)* | | | | |
| Crystallographic | hexagonal | hexagonal | hexagonal | cubic |
| form^{#} | | | | |
| Purity (%)^{#} | >99.8 | >99 | >99 | 99.1 |
| Color | white | white | white | brown |

*values measured;
^{#}values communicated by the suppliers;
NA: values not available

The size values measured confirm that batches BN-3 and BN-4 are in accordance with the present invention, in contrast to batches BN-1 and BN-2.

In addition, the characteristics of batch BN-1 show that this batch is equivalent to the batch of particles described in the publication by Li et al. (2011).

Preparation of the Materials

Different composite materials, shown in table 2 below, are prepared by a method comprising the following successive steps:
mechanical mixing of the nanoparticles in 10 to 15 g of the solution of PAA in NMP. The weights of nanoparticles introduced into the solution, for each material, are shown in table 2 below;
dispersing the particles in the composition thus obtained, by sonification at an amplitude of 300 W, for 1 h, with a square exposure cycle (2 s ON and 12 s OFF);
centrifuging at 21 000 g (14 400 rev/min) for 25 min;
recovering the supernatant and spin coating on a metal substrate made of stainless steel at a rate of between 2000 and 4000 rev/min, depending on the viscosity of the solutions, for 30 s. An adhesion promoter (VM 652 from HD Microsystems) is deposited beforehand on the substrate, before the spin coating, in order to promote the adhesion of the films;
annealing at 100° C. for 1 min on a heating plate and under air, followed by annealing at 175° C. for 3 min, so as to solidify the deposited materials;
annealing of the samples at 200° C. for 20 min and then at 400° C. for 1 h, in a regulated oven under nitrogen, in order to evaporate the solvent and then to carry out the imidization of the polyimide. The temperature cycle of this final annealing step is represented in FIG. 3.

These steps are reproduced so as to obtain, for each batch, by successive spin coatings, a multilayer film with a thickness of approximately 4 μm.

Films of materials in which boron nitride nanoparticles are dispersed in the polyimide matrix, more particularly of materials in accordance with the invention (referred to as PI-BN-3, PI-BN-4(1), PI-BN-4(2) and PI-BN-4(3)) and of comparative materials not in accordance with the invention (referred to as PI-BN-1 and PI-BN-2), are thus obtained.

For each of these materials, the exact rate of loading by volume of the matrix with nanoparticles is determined by the helium pycnometry technique using a Micromeritics Accupyc 1330 pycnometer. Calibrations were carried out before each measurement. A 0.1 cm³ cell was used for the measurements. The rates of loading by volume of the polyimide matrix with nanoparticles thus measured are shown in table 2 below.

TABLE 2
characteristics of the materials formed

| | | Weight of particles | Measured rate of |
|---|---|---|---|
| | Batch of | which are | loading by volume |
| | nanoparticles | introduced into the | of the polymer matrix |
| Material | used | PAA solution (g) | with particles (%) |
| PI-BN-1 | BN-1 | 3.12 | 29.2 |
| PI-BN-2 | BN-2 | 3.01 | 30 |
| PI-BN-3 | BN-3 | 1.5 | 39.8 |
| PI-BN-4(1) | BN-4 | 0.9 | 20.6 |
| PI-BN-4(2) | BN-4 | 1.73 | 42.1 |
| PI-BN-4(3) | BN-4 | 2.84 | 57.3 |

It should be noted that, as a result of the high density of the particles of the comparative batches BN-1 and BN-2, it is not possible with these batches to produce materials having a rate of loading by volume with nanoparticles of greater than 30% and in which the nanoparticles are correctly dispersed.

TEM images of the films thus obtained are acquired using a Jeol JEM1400 transmission microscope, the voltage used being 120 kV. To this end, the films were detached from the substrates, cut up by microtomy, in order to obtain a strip with a thickness of approximately 100 nm, and then attached to a grid. The images obtained are shown in FIG. 4. It is observed therein that the films of PI-BN-1 and PI-BN-2 not in accordance with the invention exhibit numerous agglomerates with a size of greater than 0.5 μm, whereas the film of PI-BN-3 in accordance with the invention exhibits agglomerate sizes of less than 0.5 μm and the film of PI-BN-4 in accordance with the invention exhibits agglomerate sizes of much less than 0.3 μm.

As additional comparative example, a film of the same polyimide not comprising nanoparticles as filler, referred to as PI, was also formed on an identical metal substrate.

### Example 2

### Electrical Tests at High Temperatures

2.1/ Test Structures

The electrical measurements are carried out, on the films of materials formed in Example 1 above, using capacitive structures of metal-insulator-metal (MIM) type.

In order to form these structures, metallization with a layer of gold was carried out by evaporation under high vacuum at 10⁻⁶ Torr, with a thickness of 150 nm, over the whole of the surface of the films of materials PI-BN formed in Example 1 on the metal substrate.

A step of etching through a photolithographic mask subsequently made it possible to define the geometry of the upper electrodes made of gold. More specifically, these upper electrodes were configured so as to exhibit a substantially circular shape in cross section, with a diameter of 5 mm.

2.2/ Test Equipment and Methods

The measurements of permittivity (∈), dielectric loss factor (tan δ) and DC volume resistivity (ρ) are carried out by broadband dielectric spectroscopy using a Novocontrol Alpha-A device. The latter makes possible the characterization of the samples over a range of temperatures extending from 25° C. to 350° C. under nitrogen and for frequencies of between 10⁻¹ and 10⁶ Hz, under an effective alternating voltage of 500 mV. The regulation in temperature and the resolution of the dielectric loss factor are respectively ensured at ±0.1° C. and 5×10⁻⁵.

The measurements of leakage current and of dielectric breakdown field are carried out using a Signatone S-1160 probe station equipped with micropositioners and with a sample holder which is regulated in temperature between 25 and 350° C. (±1° C.) by an S-1060R heating system. The station is positioned in a Faraday cage. The electrical signals are applied using low noise coaxial probes. Furthermore, the sample is electrically insulated, via an alumina plate, from the sample holder, itself connected to earth. During the measurements, the temperature of the sample is controlled using a type K thermocouple placed in contact on the surface of the film of PI-BN material.

The measurements of leakage current and of DC dielectric breakdown field are carried out using a Keithley SM 2410 source provided with an internal voltage source (voltage gradient from 0 to 1100 V, 8 V/s) and with a nanoammeter (0.1 nA to 20 mA). At breakdown, the voltage at the terminals of the sample become zero and the voltage source thus tips over into a current source where a limitation current (or short circuit current I_{cc}) has been preset at 20 mA. The tests are carried out by following the standard ASTM D149-97a relating to the breakdown tests on solid insulators. The value of the breakdown field E_{BR} is thus calculated through the relationship:

E_{BR}=V_{BR}/d

where V_{BR} is the breakdown voltage and d is the thickness of the insulating material.

As electrical breakdown is a random phenomenon which is a consequence of a distribution, itself random, of the defects in the insulator, the experimental measurements are carried out on a number of samples of twenty capacitive structures for each temperature and for each material. A statistical treatment is carried out using the two-parameter Weibull distribution law.

2.3/ Measurement of the Dielectric Breakdown Field

The minimum dielectric breakdown field, calculated for the twenty capacitive structures tested for each material, was determined, for different temperatures, for the following different materials: PI (filler-free polymer), materials not in accordance with the invention, PI-BN-1 and PI-BN-2, and materials in accordance with the invention, PI-BN-3 and PI-BN-4(2).

The results obtained are shown in FIG. 5. They clearly show that the minimum dielectric breakdown field remains very high, in the vicinity of 4 MV/cm, at the temperatures greater than 200° C. for the materials in accordance with the invention, in contrast to the comparative materials, that is to say to the material not comprising nanoparticles as filler and to the materials comprising nanoparticles with a size greater than that recommended by the present invention as filler, for which this dielectric breakdown field collapses with the rise in temperature. This demonstrates the superiority in electrical insulating performance of the materials in accordance with the invention at high temperature and under a strong electric field.

The same experiment was carried out for the three materials in accordance with the invention PI-BN-4(1), PI-BN-4(2) and PI-BN-4(3), with a similar constitution but exhibiting different rates of loading by volume with nanoparticles.

The results are shown in FIG. 6. It is observed therein that all of these materials exhibit a minimum dielectric breakdown field which remains high at high temperatures. The material PI-BN-4(2), which exhibits a content of loading by volume of nanoparticles of 42.1%, exhibits the best performance.

2.4/ Measurement of Volume Resistivity

In order to clearly demonstrate the advantages of the present invention, the volume resistivity was measured as a function of the temperature, at temperatures of greater than 200° C., for the following different films of electrically insulating heat-stable polymers available commercially: Kapton®-HN (Goodfellow, 50 μm), polyaramid (PA) (Goodfellow, 50 μm reference T410), PEEK (Goodfellow, 50 μm amorphous) and polyamideimide (PAI) (diphenylmethane diisocyanate and trimellitic anhydride, 5 μm).

To this end, a MIM structure comprising a film of each of these polymers was formed and the volume resistivity was measured. The results obtained are shown in FIG. 7. It is observed therein that the volume resistivity of each of these polymers falls with the rise of temperature, these materials rapidly becoming semi-insulating.

In addition, the volume resistivity was measured, at different temperatures greater than 200° C., for the films of materials in accordance with the invention PI-BN-4(1) and PI-BN-4(2) and for the comparative films PI-BN-1, PI-BN-2 and PI.

The results obtained are shown in FIG. 8. The materials according to the invention here again show therein a better performance than the comparative materials at the high temperatures, including for those having a lower rate of loading by volume with nanoparticles (20% for PI-BN-4(1)). This good preservation of the volume resistivity of the materials according to the invention at high temperatures makes it possible for them to be maintained in the range of electrical insulators (volume resistivity greater than 10¹²Ω) well beyond 200° C.

2.5/ Measurement of the Permittivity and of the Dielectric Loss Factor

The change in the permittivity (∈) and in the dielectric loss factor (tan δ) to 1 kHz, as a function of the temperature, was measured for the material in accordance with the invention PI-BN-4(2) and for the comparative material PI not comprising nanoparticles as filler.

The results obtained are shown in FIG. 9 for the permittivity and in FIG. 10 for the dielectric loss factor. As may be seen in these figures, the material in accordance with the invention, PI-BN-4(2), exhibits a strong reduction in the level of dielectric losses, by a factor of approximately 10 at 250° C., of approximately 100 at 300° C. and of approximately 1000 at 350° C., with respect to the comparative material PI, and a stabilization in the permittivity over the entire range of temperatures. Furthermore, the level of the dielectric losses of the material in accordance with the invention remains less than or equal to 1% over the whole of the range of temperatures up to 350° C., in contrast to the filler-free material.

2.6/ Measurement of the Leakage Currents

The change in the leakage currents as a function of the electric field, for three temperatures (200° C., 250° C. and 300° C.), was measured for the material in accordance with the invention PI-BN-4(2) and for the comparative material PI not comprising nanoparticles as filler.

The results obtained are shown in FIG. 11. It is observed therein that the material in accordance with the invention PI-BN-4(2) shows good maintenance of the levels of leakage currents, of less than 100 nA/cm² under 100 kV/cm and of less than or equal to 1 μA/cm² under 1 MV/cm, this being the case up to 300° C. Thus, the leakage current densities of the material in accordance with the invention are decreased by a factor of 10 to 100 000 with respect to the comparative material PI, at these high temperatures.

### EXPERIMENT B

### Composite Materials: Polyimide Matrix—Aluminum Nitride or Silicon Nitride Nanoparticles

Preparation of the Materials

The following different materials were prepared in the film form.

For each of these materials, the polymer matrix is identical to that described in Experiment A.

The inorganic nanoparticles in accordance with the present invention are of two types: aluminum nitride (AlN) nanoparticles, denoted AlN in the present description, and silicon nitride (Si₃N₄) nanoparticles, denoted SiN in the present description.

In addition to the characteristics communicated by the suppliers, the true size characteristics of the nanoparticles of each batch were established from observations by transmission electron microscopy (TEM), on the one hand, and by laser particle size analysis, on the other hand.

The TEM images were obtained as described in the Experiment A. An example of an image obtained for each type of AlN and SiN nanoparticles is shown in FIG. 12. It is observed therein that the nanoparticles all exhibit dimensions of less than 200 nm.

The measurement by laser particle size analysis was carried out as described in Experiment A. The result obtained for each of the types of nanoparticles, in terms of size distribution of the nanoparticles, is shown in FIG. 13. It is clearly observed therein that the nanoparticles exhibit a single distribution, with all the particles having dimensions of less than 200 nm.

The minimum, maximum and mean particle diameters, for each batch and for each distribution, are also extracted from these measurements.

The characteristics of the different batches are summarized in table 3 below.

TABLE 3
characteristics of nitride particles employed

| Nanoparticles | AlN | SiN |
|---|---|---|
| Density (g/cm³)* | 3.01 | 2.67 |
| Shape of the nanoparticles | pseudospherical | pseudospherical |
| Type of distribution of the sizes* | monomodal | monomodal |
| Mean diameter (nm)* | 68 | 59 |
| Minimum diameter (nm)* | 28 | 33 |
| Maximum diameter (nm)* | 120 | 164 |
| Specific surface (m²/g)* | 69.8* | 30.3* |
| Crystallographic form^{#} | NA | amorphous |
| Purity (%)^{#} | 99 | 99 |
| Color | white | white |

*values measured;
^{#}values communicated by the suppliers;
NA: values not available

The size values measured confirm that these nanoparticles are in accordance with the present invention.

The preparation of the materials in accordance with the invention, based on these different nanoparticles, was carried out as described in Experiment A.

For each of the types of nanoparticles, rates of loading by weight of 1%, 3% and 5% were produced.

Films of materials in which nitride nanoparticles are dispersed in the polyimide matrix, more particularly of materials in accordance with the invention referred to respectively as PI-AlN and PI-SiN, were thus obtained.

Materials PI-BN-4 and PI-BN-1, in accordance with Experiment A, with rates of loading by weight with nanoparticles of 1%, 3% and 5%, were also prepared, as comparative examples.

A film of the same polyimide not comprising nanoparticles as filler, referred to as PI, was also formed on an identical metal substrate.

Measurement of the Leakage Currents

The change in the leakage currents as a function of the electric field, at a temperature of 250° C., was measured for the materials in accordance with the invention PI-BN-4 (having a rate of loading by weight with nanoparticles of 1%), PI-AlN and PI-SiN (each having a rate of loading by weight with nanoparticles of 3%), and also for the comparative material PI not comprising nanoparticles as filler.

The results obtained are shown in FIG. 14. It is observed therein that the materials in accordance with the invention all show good maintenance of the levels of leakage currents at 250° C., these leakage currents being much lower than those of the polyimide not comprising nanoparticles as filler (PI).

The change in the leakage currents as a function of the electric field, for three temperatures (200° C., 250° C. and 300° C.), was measured for each of the materials in accordance with the invention PI-AlN and PI-SiN, having contents of loading by weight with nanoparticles respectively of 3% and 5%, and for the comparative material PI not comprising nanoparticles as filler.

The results obtained are shown in FIG. 15 for PI-AlN and in FIG. 16 for PI-SiN. It is observed therein that the materials in accordance with the invention show good maintenance of the levels of leakage currents, these leakage currents being much lower than those of the polyimide not comprising nanoparticles as filler (PI), this being the case up to 300° C.

Measurement of Volume Resistivity

The volume resistivity of the materials in accordance with the invention PI-AlN, PI-SiN and PI-BN-4 and of the polyimide alone (PI) was measured, as a function of the temperature, at temperatures of greater than 200° C., as described in Experiment A. The rates of loading by weight with nanoparticles were as follows: PI-BN-4: 1%; PI-AlN: 3% and 5%; PI-SiN: 3% and 5%.

The results obtained are shown in FIG. 17. The materials according to the invention here again show herein a better performance than the comparative material at high temperatures.

Measurement of the Permittivity and of the Dielectric Loss Factor

The change in the permittivity (∈) and of the dielectric loss factor (tan δ) at 1 kHz, as a function of the temperature, was measured as described in experiment A for the materials in accordance with the invention PI-AlN, PI-SiN and PI-BN-4 and for the comparative material PI not comprising nanoparticles as filler. The rates of loading by weight with nanoparticles were as follows: PI-BN-4: 1%; PI-AlN: 3% and 5%; PI-SiN: 3% and 5%.

The results obtained are shown in FIG. 18 for the permittivity and in FIG. 19 for the dielectric loss factor. As can be seen in these figures, the materials in accordance with the invention all exhibit a strong reduction in the level of dielectric losses with respect to the comparative material PI and a stabilization in the permittivity over the entire range of temperatures.

Measurement of the Dielectric Breakdown Field

The minimum dielectric breakdown field was determined, as described in Experiment A, for respective temperatures of 300° C. and 350° C., for the following different materials: PI (filler-free polyimide) and materials in accordance with the invention PI-AlN and PI-SiN. The rates of loading by weight with nanoparticles were as follows: 1%, 3% and 5%.

The results obtained are shown in FIG. 20. They clearly show that, at temperatures as high as 300° C. and 350° C., the minimum dielectric breakdown field remains higher, for the materials in accordance with the invention, than for the material not comprising nanoparticles as filler. This demonstrates the superiority in the electrical insulation performance of the materials in accordance with the invention at high temperature and under a strong electric field.

### EXPERIMENT C

### Composite Materials: Silicone Matrix—Boron Nitride Nanoparticles

Preparation of the Materials

In this experiment, the matrix is a silicone gel (Semicosil® 945 HT from Wacker Silicones). Its density is 0.97 g/cm³. Its viscosity at ambient temperature is 1000 mPa·s. It is a material comprising two components (ratio for the mixture 10:1).

The nanoparticles are boron nitride nanoparticles BN-4 described in Experiment A.

The material in accordance with the invention was prepared in the following way.

The nanoparticles, in an amount appropriate for obtaining a content of 1% by weight of nanoparticles in the matrix, were mixed in 10 g of silicone precursor, before being dispersed therein with an ultrasonic probe at 225 W for 30 min, using a square exposure cycle (2 s ON and 9 s OFF).

The curing agent was subsequently added (ratio 10:100) with a pipette and the mixture obtained was stirred mechanically for 3 min. The mixture was degassed under vacuum and then poured between two stainless steel plates (33×33×1 mm) separated by four layers, each with a thickness of 50 μm (i.e., a total thickness of 200 μm), of Kapton® adhesive tape placed on the four edges of the plates.

The crosslinking of the silicone matrix was carried out in an oven at 100° C. in the air for 30 min.

As the silicone gel obtained does not exhibit a mechanical hardness, the metal plates of the mold were used as electrodes for the electrical characterizations.

A control formed of the silicone gel alone, that is to say not comprising nanoparticles, was also prepared.

Measurement of Volume Resistivity

The volume resistivity of the material in accordance with the invention and that of the silicone gel alone were measured, as a function of the temperature, at temperatures of between 150 and 250° C., directly on the samples molded with the plates of the mold and according to the protocol described in Experiment A.

The results obtained are shown in FIG. 21. The material according to the invention shows therein a better performance than the comparative material over the entire range of temperatures tested, including at the temperatures greater than or equal to 200° C.

The description above clearly illustrates that, by its different characteristics and their advantages, the present invention achieves the objectives which it had set itself. In particular, it provides an electrically insulating material which advantageously exhibits, at high temperatures of greater than 200° C. and under a strong electric field, a superior performance with respect to the materials of the prior art.

### BIBLIOGRAPHICAL REFERENCES

Feng et al. (2013), Material Letters, 96, 113-116
Li et al. (2011), Journal of Applied Polymer Sciences, 121, 916-922
Sato et al. (2010), J. Mater. Chem., 20, 2749-2752
Sroog (1991), Prog. Polym. Sci., 16, 561

1-15. (canceled)

16. An electrically insulating material, comprising a matrix of a heat-stable and electrically insulating polymer, in which electrically insulating inorganic nanoparticles are dispersed, wherein the electrically insulating inorganic nanoparticles are chosen from electrically insulating metal nitrides, diamond, electrically insulating oxides of at least one metal from Groups 1 to 11 of the Periodic Table of the Elements, and their mixtures, and wherein all of said electrically insulating inorganic nanoparticles exhibit dimensions of less than or equal to 200 nm.

17. The material as claimed in claim 16, wherein said electrically insulating inorganic nanoparticles exhibit an overall spherical shape.

18. The material as claimed in claim 16, wherein said electrically insulating inorganic nanoparticles exhibit a monomodal size distribution.

19. The material as claimed in claim 16, wherein said electrically insulating inorganic nanoparticles are present in said matrix in a ratio by volume of 0.1 to 95%.

20. The material as claimed in claim 16, wherein said electrically insulating inorganic nanoparticles are present in said matrix in a ratio by volume of 35 to 45%.

21. The material as claimed in claim 16, wherein said electrically insulating inorganic nanoparticles are dispersed in said matrix so as not to form any agglomerate having a size of greater than or equal to 2 μm.

22. The material as claimed in claim 16, wherein said electrically insulating heat-stable polymer is a polyimide.

23. The material as claimed in claim 16, wherein said electrically insulating heat-stable polymer is a silicone.

24. The material as claimed in claim 16, wherein said electrically insulating inorganic nanoparticles are metal nitride nanoparticles.

25. The material as claimed in claim 16, wherein said electrically insulating inorganic nanoparticles are boron nitride nanoparticles.

26. The material as claimed in claim 16, shaped in the form of a film.

27. The material as claimed in claim 26 wherein said film exhibits a thickness of between 100 nm and 1 cm.

28. A method for the manufacture of a material as claimed in any one of claim 16, comprising the steps of:
dispersing electrically insulating inorganic nanoparticles, exhibiting dimensions of less than or equal to 200 nm, in a liquid composition comprising one or more precursor(s) of a heat-stable and electrically insulating polymer, if appropriate in solution in a solvent,
shaping the dispersion thus obtained,
and heating under conditions capable of bringing about the crosslinking of said polymer and the removal of the solvent.

29. The method as claimed in claim 28, wherein the step of dispersing the nanoparticles in the liquid composition comprises the mechanical mixing of the nanoparticles in said liquid composition and then the sonification of the mixture thus obtained.

30. The method as claimed in claim 28, wherein the step of dispersing the nanoparticles in the liquid composition is followed by a step of removing the agglomerates having a size of greater than or equal to 2 μm.

31. The method as claimed in claim 30, wherein the step of removing the agglomerates having a size of greater than or equal to 2 μm is carried out by separation by settling using centrifuging.

32. Method of electrically insulating a support which comprises applying an effective amount of the material of claim 16 on the support to be electrically insulated, in the form of a film with a thickness of between 100 nm and 1 cm.

33. The method according to claim 32, wherein the film has a thickness between 100 nm and 1 mm.

34. The method according to claim 33, wherein the film has a thickness between 1 μm and 10 μm.

35. An electrical, electronic or electrical engineering system comprising, as electrical insulator, a film of a material as claimed in claim 16.
